(19) United States
(12) Patent Application Publication
(10) Pub. No.: US 2007/0296358 A1
(43) Pub. Date: Dec. 27, 2007

(54) Power Output Apparatus and Vehicle Equipped Therewith

(75) Inventors: Eiji Sato, Nishikamo-gun (JP); Akira Hirai, Osaka-shi (JP); Toshihiro Sumitani, Sanda-shi (JP)

Correspondence Address: OLIFF & BERRIDGE, PLC, P.O. BOX 320850, ALEXANDRIA, VA, 22320-4850, US

(73) Assignees: TOYOTA JIDOSHA KABUSHIKI KAISHA, TOYOTA-SHI, AICHI-KEN (JP); DAIHATSU MOTOR CO., LTD., IKEDA-SHI, OSAKA (JP)

(21) Appl. No.: 11/792,223

(22) PCT Filed: Dec. 13, 2005
(86) PCT No.: PCT/IB05/03750

§ 371 Date: Jun. 4, 2007

(30) Foreign Application Priority Data
Dec. 14, 2004 (JP) 2004-361020

(51) Int. Cl. H02P 3/00; H02P 25/16

(52) U.S. Cl. 318/139; 318/154; 318/440

(57) ABSTRACT

An on-off duty ratio of a transistor that increases and decreases a current applied to a field coil of an alternator is monitored. When the duty ratio is 100%, the electric generation capability of the alternator is at a maximum, and the battery current of a battery exceeds a predetermined current limit. Under these conditions, a torque limit is set to tighten a limit on the torque output from a motor. The motor is thus controlled within a range determined by the set torque limit. As a result, the motor can be controlled while the electric power outputs and requirements of the alternator, the battery and the motor are balanced, without having to directly detect the high voltage electric power of the alternator. Accordingly, the flow of excessive current in the battery can be impeded, and deterioration of the battery can be avoided.

### BACKGROUND OF THE INVENTION

1. Field of the Invention

The invention relates to a power output apparatus and a vehicle equipped with the apparatus.

2. Description of the Related Art

A power output apparatus that includes an engine, an alternator, a motor, a battery, and a direct-current (DC) voltage converter is described in Japanese Patent Application Publication No. JP 2000-245008 A. In the described apparatus, the engine generates power to drive the front wheels and to turn the alternator to generate electric power, and the motor outputs power to drive the rear wheels using the electric power generated by the alternator. The battery is connected in parallel with the alternator to the motor, and the DC voltage converter converts the voltage of the electric power from the alternator and supplies it to an electric load (i.e., an auxiliary device). In this apparatus, if the remaining charge of the battery becomes low, or if the electric power consumed by the electric load exceeds a predetermined amount, the supply of electric power to the motor is cut off and the electric power from the alternator is supplied to the electric load via the DC converter.

However, in the described power output apparatus, there are occasions when the motor is not able to perform at its full potential or the battery deteriorates. Normally, the amount of power generated by the alternator may be adjusted by increasing or decreasing the current applied to the field coil so that the battery voltage, which fluctuates due to energy consumption by the motor, is maintained at a constant level. However, in the described power output apparatus, the amount of power generated by the alternator is not taken into consideration. As a result, the power output from the motor may be unnecessarily restricted even though the power output of the alternator is adequate. Alternatively, under certain circumstances, the ratio of the power output from the motor to the power amount from the alternator may become excessive, which may lead to deterioration of the battery due to the excessive flow of current. To address these problems, the power output of the alternator may be directly detected and used to control the motor. However, with such a configuration, a separate sensor for detecting the power output of the alternator, which has a comparatively high voltage, must be provided, thus increasing cost substantially.

### SUMMARY OF THE INVENTION

In light of the above problems, the invention provides a power output apparatus that appropriately adjusts the power output from a motor to enable the motor to perform at its full potential, without requiring direct detection of the amount of power generated by a generator. The invention also provides a vehicle equipped with the apparatus. The power output apparatus and the vehicle equipped therewith can also avoid over discharge of a storage means, such as a battery, without having to directly detect the power generation amount of the generator.

The power output apparatus according to the invention includes a motor, a generator, energization state detection means, and control means. The motor can output power, and the generator generates electric power while adjusting energization of an exciting coil that is energized in accordance with energy consumed by the motor. The generator supplies electric power to the motor. The energization state detection means detects the energization state of the exciting coil, and the control means controls drive of the motor based on the detected energization state.

In the power output apparatus of the invention, the energization state of the exciting coil of the generator is detected. Drive of the motor is then controlled based on the detected energization state. As a result of using the energization state to determine the amount of electric power generated by the generator, it is possible to appropriately adjust the power output from the motor without having to directly detect the amount of power generated by the generator.

In the above power output apparatus of the invention, the control means may control the drive of the motor such that the output from the motor is restricted when the energization state of the exciting coil approaches or has reached a maximum value. With this configuration, the power output from the motor can be appropriately adjusted using a simple process.

The power output apparatus of the invention may further include storage means for storing electric power from at least one of the generator and the motor and distributing electric power to at least one of the generator and the motor; and discharge state detection means for detecting a discharge state of the storage means. With this configuration, the control means may control drive of the motor based on both the detected energization state of the exciting coil and the detected discharge state of the storage means. Accordingly, over discharge of the storage means can be suppressed using a simple process.

In this form of the power output apparatus of the invention, the control means may control the drive of the motor such that power output from the motor is restricted when both the detected energization state of the exciting coil approaches or has reached a maximum value, and the detected discharge state of the storage means has reached a predetermined discharge state. As a result, over discharge of the storage means can be suppressed using a simple process.

Additionally, in the power output apparatus of the invention, energization of the exciting coil may be adjusted by changing a duty ratio so as to drive a switching device. Further, the energization state detection means may detect the duty ratio. Alternatively, the energization state detection means may detect an inter-terminal voltage of the exciting coil, or a current flowing in the exciting coil.

The vehicle according to the invention may be equipped with any one of the above described forms of the power output apparatus of the invention. More specifically, the vehicle is equipped with the power output apparatus, which includes: (i) the motor that outputs power; (ii) the generator that generates electric power while adjusting energization of the exciting coil, which is energized in accordance with energy consumed by the motor, and supplies the electric power to the motor; (iii) the energization state detection means for detecting the energization state of the exciting coil; and (iv) the control means for controlling drive of the motor based on the detected energization state.

The vehicle according to the invention may be equipped with any one of the above forms of the power output apparatus of the invention and thus can achieve the same effects as the power output apparatus. For example, the power output from the motor can be appropriately adjusted without having to directly detect the power generation amount of the generator, and over discharge of the storage means can be suppressed.

### BRIEF DESCRIPTION OF THE DRAWINGS

The features, advantages thereof, and technical and industrial significance of this invention will be better understood by reading the following detailed description of a preferred embodiment of the invention, when considered in connection with the accompanying drawings, in which:

FIG. 1 shows the outline of a configuration for a hybrid vehicle according to an embodiment of the invention;

FIG. 2 shows an outline of a structural configuration including an output voltage adjustment circuit as a main element; and

FIG. 3 is a flow chart showing an example of a drive control routine that is performed by an electronic control unit of the hybrid vehicle according to the embodiment.

### DETAILED DESCRIPTION OF THE PREFERRED EMBODIMENTS

The following description and accompanying drawings describe the present invention in more detail within the context of a particular embodiment of the invention.

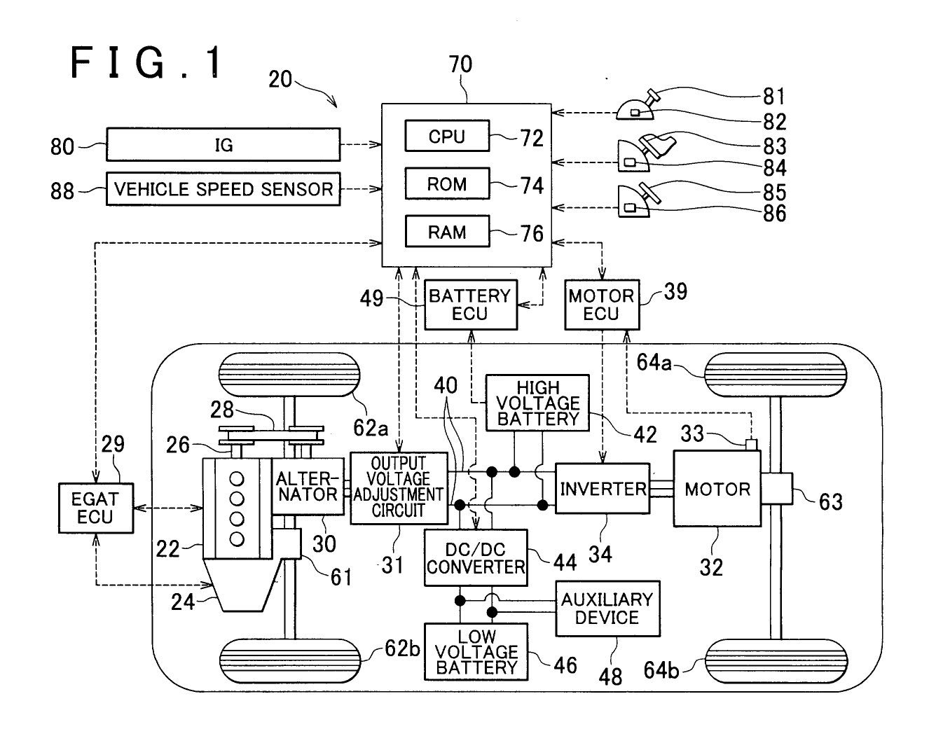

FIG. 1 shows the outline of a configuration for a hybrid vehicle 20 equipped with a power output apparatus according to one embodiment of the invention. The hybrid vehicle 20, as can be seen from FIG. 1, includes an engine 22, an automatic transmission 24, an alternator 30, an output voltage adjustment circuit 31, a motor 32, a high voltage battery 42, and an electronic control unit 70. The automatic transmission 24 is connected to a crank shaft 26 of the engine 22 and is coupled to front wheels 62a, 62b via a differential gear 61. The automatic transmission 24 changes the rotational speed of the output from the engine 22 and transmits it to the front wheels 62a, 62b. The alternator 30 is driven by a belt 28 that is looped around the crankshaft 26 of the engine 22. The output voltage adjustment circuit 31 adjusts the voltage of the output from the alternator 30. The motor 32 can output power to rear wheels 64a, 64b via a differential gear 63 using electric power from the alternator 30. The high voltage battery 42 is connected to a power line 40 extending between the alternator 30 and the motor 32, and is connected in parallel with the alternator 30 to the motor 32. The electronic control unit 70 controls the overall drive train of the hybrid vehicle 20.

The engine 22 is an internal combustion engine that generates power by combustion of a hydrocarbon fuel such as gasoline. An engine-transmission electronic control unit (hereinafter referred to as “EGATECU”) 29 performs operation control of the engine 22 and the automatic transmission 24 connected to the crankshaft 26 of the engine 22 and the differential gear 61. Various signals are input to an input port of the EGATECU 29, including a rotational speed Ne of the engine 22 that is detected by a rotational speed sensor, not shown. The EGATECU 29 communicates via a communication port with the electronic control unit 70. The EGATECU 29 uses signals from the electronic control unit 70 to control the engine 22 and the automatic transmission 24, and, when necessary, transmits data concerning the operating state of the engine 22 and the automatic transmission 24 to the electronic control unit 70.

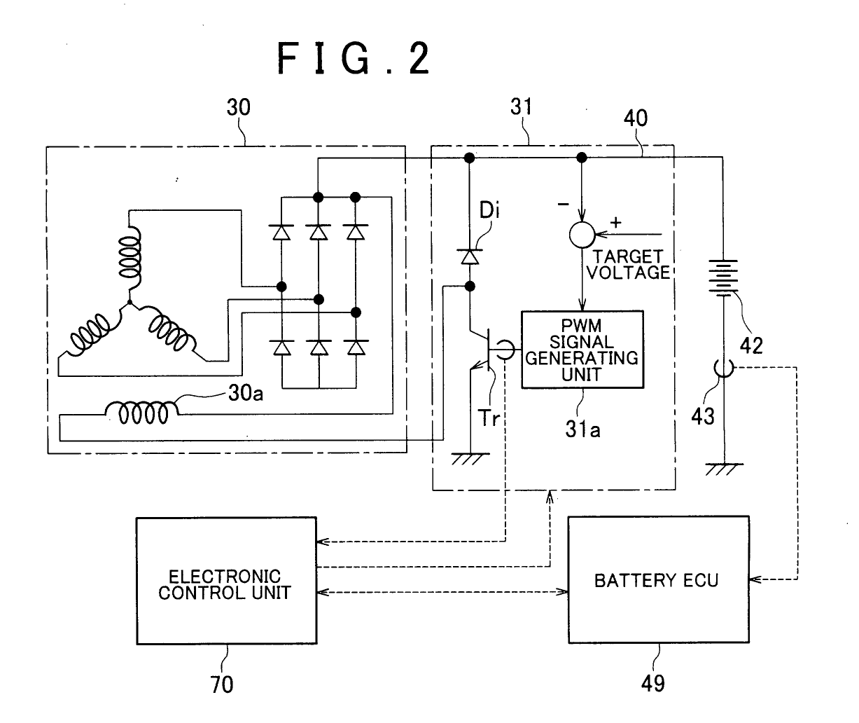

The alternator 30 comprises a known three-phase alternating current motor to which a full-wave rectifier is connected. FIG. 2 shows a structural configuration including the output voltage adjustment circuit 31 as a main element. As can be seen from FIG. 2, the output voltage adjustment circuit 31 includes a transistor Tr and a PWM signal generating unit 31a. The transistor Tr has a collector that is connected to (i) a positive electrode of the high voltage battery 42, and (ii) an output terminal of the alternator 30 via a field coil 30a of the alternator 30 and a forward biased diode Di that are connected in parallel; and an emitter that is grounded. The PWM signal generating unit 31a generates a PWM signal based on a comparison of the voltage of the positive electrode of the high voltage battery 42 and a target voltage thereof, and outputs the PWM signal to a base of the transistor Tr. When the voltage of the positive electrode of the high voltage battery 42 is less than the target voltage, the PWM signal generating unit 31a generates a PWM signal with a large duty ratio Du. More specifically, the duty ratio Du is increased as the-difference between the voltage and the target voltage increases. On the other hand, when the voltage of the positive electrode of the high voltage battery 42 is higher than the target voltage, the PWM signal generating unit 31a generates a PWM signal with a small duty ratio Du. More specifically, the duty ratio Du is decreased as the difference between the voltage and the target voltage increases. By varying the PWM signal in this manner, the transistor Tr is switched on and off so as to increase and decrease the field current applied to the field coil 30a. Accordingly, the voltage of the positive electrode of the high voltage battery 42 is adjusted to the target voltage. When the transistor Tr is driven with the duty ratio Du set to 100%, the electric power generation capability of the alternator 30 is at a maximum. Note that, since the voltage of the positive electrode of the high voltage battery 42 reflects the energy consumed by the motor 32, in effect, the PWM signal generating unit 31a adjusts the duty ratio Du of the transistor Tr in accordance with the energy consumed by the motor 32. The output voltage adjustment circuit 31 is controlled by the electronic control unit 70. The electronic control unit 70 receives and monitors the PWM signal (the duty ratio Du) output by the PWM signal generating unit 31a.

The motor 32 is configured such that it can be driven to act as motor, or as a synchronous generator-motor that acts as a generator. The motor 32 is connected via the inverter 34 and the power line 40 to the output voltage adjustment circuit 31 of the alternator 30, the high voltage battery 42, etc. Drive of the motor 32 is controlled by a motor electronic control unit (hereinafter referred to as “motor ECU”) 39. The motor ECU 39 receives signals that are necessary for controlling the drive of the motor 32. These signals are input to an input port of the motor ECU 39 and include, for example, a rotational position signal from a rotational position detecting sensor 33 that detects a rotational position of a rotor, not shown, of the motor 32, and a current signal from a current sensor, not shown, that detects a phase current applied to the motor 32. The motor ECU 39 then outputs signals via an output port such as a switching control signal for the inverter 34. The motor ECU 39 communicates via a communication port with the electronic control unit 70, and controls the drive of the motor 32 based on signals from the electronic control unit 70, and outputs data concerning the operating state of the motor 32 to the electronic control unit 70 as necessary.

The high voltage battery 42 is controlled by a battery electronic control unit (hereinafter referred to as “battery ECU”) 49. The battery ECU 49 receives signals that are necessary for controlling the high voltage battery 42. These signals are input to an input port of the battery ECU 49 and include, for example, a current signal from a current sensor 43 (refer to FIG. 2) that detects the charge/discharge current of the high voltage battery 42; a voltage signal from a voltage sensor, not shown, that detects the inter-terminal voltage of the high voltage battery 42: and a temperature signal from a temperature sensor, not shown, that detects the temperature of the high voltage battery 42. The battery ECU 49 communicates via a communication port with the electronic control unit 70, and outputs data concerning the state of the high voltage battery 42 to the electronic control unit 70 as necessary. The battery ECU 49 also calculates a remaining charge SOC by integrating the charge/discharge current of the high voltage battery 42 detected by the current sensor.

A DC/DC converter 44 is connected to the power line 40, which connects the alternator 30 (the output voltage adjustment circuit 31) to the motor 32 (the inverter 34). This DC/DC converter 44 can convert the voltage of the electric power from the alternator 30 or the high voltage battery 42 and supply the electric power to a low voltage battery 46 or an auxiliary device 48. The DC/DC converter 44 is controlled by the electronic control unit 70.

The electronic control unit 70 is configured from a microprocessor including a CPU 72 as a main element. The electronic control unit 70 also includes a ROM 74 that stores processing programs, a RAM 76 that temporarily stores data, and an input port, an output port, and a communication port, not shown. Various signals are input to the input port of the electronic control unit 70. These signals include an ignition signal from an ignition switch 80; a shift position SP signal from a shift position sensor 82 that detects an operation position of a shift lever 81; an accelerator opening degree Ace signal from an accelerator pedal position sensor 84 that detects a depression amount of an accelerator pedal 83; a brake pedal position BP signal from a brake pedal position sensor 86 that detects a depression amount of a brake pedal 85; and a vehicle speed V signal from a vehicle speed sensor 88. The electronic control unit 70 outputs various signals from the output port such as a control signal for adjusting the output voltage of the alternator 30 that is output to the output voltage adjustment circuit 31, and a switching control signal for a switching device, not shown, of the DC/DC converter 44. As will be apparent from the previous description, the electronic control unit 70 is connected via the communication port to the EGATECU 29, the motor ECU 39, and the battery ECU 49, and various control signals and other data are transmitted therebetween.

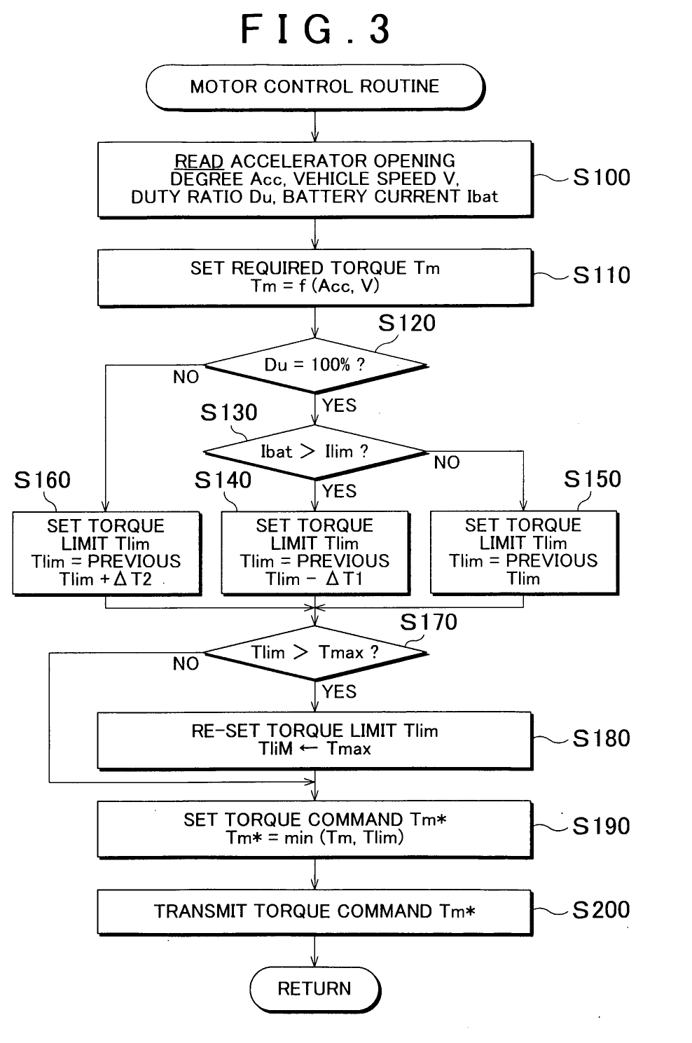

Next, the operation of the hybrid vehicle 20 of the above described embodiment will be explained. More specifically, the operation when drive of the motor 32 is controlled will be discussed. FIG. 3 is a flow chart showing an example of a motor control routine that is performed by the electronic control unit 70 of the embodiment. This routine is repeatedly performed within a predetermined time period (for example, a few msec). Note that, control of the engine 22 and the automatic transmission 24 is performed by sending signals based on the accelerator opening degree Acc, the vehicle speed V, etc., to the EGATECU 29. The EGATECU 29 uses these signals as a basis for performing operation control of both the engine 22 and the automatic transmission 24. The control of the engine 22 and the automatic transmission 24 is not directly related to this invention and thus a detailed explanation is omitted here.

When the motor control routine is performed, first, data for signals etc. are read by the electronic control unit 70 (step S100) and input to the CPU 72. The signals include the accelerator opening degree Acc from the accelerator pedal position sensor 84, the vehicle speed V from the vehicle speed sensor 88, the duty ratio Du of the PWM signal output from the PWM signal generating unit 31a, and a battery current Ibat, etc. Note that, the battery current Ibat is transmitted and input from the battery ECU 49 based on the detection of the current sensor 43.

Once the above data has been input, a required torque Tm that needs to be output from the motor 32 is set based on the input accelerator opening degree Acc and the vehicle speed V (step S110). The required torque Tm is set, in this embodiment, using a map showing the relationship between the accelerator opening degree Acc, the vehicle speed V, and the required torque Tm that is pre-stored in the ROM 74. If the accelerator opening degree Acc and the vehicle speed V are known, the map can be used to derive and set the required torque Tm.

Next, it is determined if the input duty ratio Du is 100% (step S120). As described previously, when the transistor Tr is driven with the duty ratio Du of the signal generated by the PWM signal generating unit 31a set to 100%, the electric power generation capability of the alternator 30 is at the maximum. Accordingly, the processing of step S120 determines whether the electric power generation capability of the alternator 30 is at the maximum. If the duty ratio Du is determined to be 100%, it is determined that the electric power generation capability of the alternator 30 has no margin for further increase. Then, it is determined whether the input battery current That is larger than a current limit Ilim (step S130). The current limit Ilim is a value that enables determination of whether the current flowing to the high voltage battery 42 is a comparatively large current that is large enough to cause deterioration of the high voltage battery 42. This current limit Ilim is set based on the performance of the high voltage battery 42, etc. When the battery current Ibat is determined to be larger than the current limit Ilim, the electronic control unit 70 gradually tightens the limit on the torque output from the motor 32. More specifically, the torque limit set for the previous routine (referred to hereinafter as “previous torque limit Tlim”) is reduced by a predetermined value ΔTI to set a new torque control limit Tlim (step S140). As the initial value of the torque limit Tlim, for example, the rated value of the motor 32 may be set. As a result of setting the torque limit Tlim in this way, excessive current is impeded from flowing in the high voltage battery 42, and deterioration of the high voltage battery 42 is avoided. The predetermined value ΔT1 is set while making sure that vehicle shock and vibration, which occur if the limit on the torque output from the motor 32 is tightened too suddenly, are kept to a minimum. The predetermined value ΔT1 is based on the interval between each cycle of the routine, etc. When the battery current Ibat is determined to be equal to or less than the current limit Ilim, it is determined that the current flowing is not large enough to cause deterioration of the high voltage battery 42, and thus the processing proceeds to the next step without the torque limit Tlim being changed (step S150).

On the other hand, when it is determined that the duty ratio Du is not 100%, the electronic control unit 70 determines that the electric power generation capability of the alternator 30 has margin to be increased. Accordingly, the new torque limit Tlim is set such that the limit on the torque output from the motor 32 is gradually relaxed. More specifically, the new torque limit Tlim is set by adding a predetermined value ΔT2 to the torque limit (the previous torque limit Tlim) set for the previous cycle of the routine (step S160). As a result, when there is margin to increase the electric power generation of the alternator 30, the limit on the torque output from the motor 32 is gradually relaxed, whereby the motor 32 is able to perform nearer to its full potential. Note that, the predetermined value ΔT2 is set while making sure that vehicle shock and vibration, which occur if the limit on the torque output from the motor 32 is relaxed too suddenly, are kept to a minimum. The predetermined value ΔT2 is based on the interval between each cycle of the routine, etc.

Once the torque limit Tlim is set, the electronic control unit 70 compares the set toque limit Tlim and an upper limit Tmax that reflects the rated value of the motor 32 (step S170). When the torque limit Tlim is determined to be equal to or less than the upper value Tmax, the processing proceeds directly to the next step. However, when the torque limit Tlim is greater than the upper limit Tmax, the upper limit Tmax is reset as the torque limit Tlim (step S180).

Next, the electronic control unit 70 sets a torque command Tm* (step S190) as the smaller value among (i) the torque limit Tlim that has been set/re-set in the above described manner and (ii) the required torque Tm set in step S110. The torque command Tm* indicates the torque that needs to be output from the motor 32. The set torque command Tm* is then transmitted to the motor ECU 39 (step S200), and the routine terminated. The motor ECU 39, which has received the torque command Tm*, performs switching control of the switching device of the inverter 34 so that the motor 32 is driven based on the torque command Tm*.

According to the described hybrid vehicle 20, the electronic control unit 70 monitors the duty ratio Du (the PWM signal) that turns on and off the transistor Tr that increases and decreases the current applied to the field coil 30a of the alternator 30 in accordance with the energy consumed by the motor 32 (i.e., the voltage of the positive electrode of the high voltage battery 42). The electronic control unit 70 then limits the torque output from the motor 32 based on the duty ratio Du, which makes it possible to balance the electric power outputs and requirements of the alternator 30, the high voltage battery 42 and the motor 32 (the DC/DC converter 44) without having to directly detect the high voltage electric power that is output from the alternator 30. Accordingly, flow of excessive current in the high voltage battery 42 can be impeded, and, as a result, deterioration of the high voltage battery 42 can be avoided.

In the hybrid vehicle 20, the electronic control unit 70 monitors the duty ratio Du that turns on and off the transistor Tr that increases and decreases the field current applied to the field coil 30a, and the torque limit Tlim of the motor 32 is set based on the duty ratio Du. However, the embodiment is not limited to this configuration, and the torque limit Tlim may be set based on any other parameter that enables the energization state of the field coil 30a to be determined. For example, the current flowing in the field coil 30a or the inter-terminal voltage of the field coil 30a may be detected. If such a configuration is adopted, control of the motor 32 can be performed while balancing the power output of the alternator 30, the high voltage battery 42 and the motor 32, without having to directly detect the high voltage electric power of the alternator 30.

In the hybrid vehicle 20, the torque limit Tlim of the motor 32 is set to gradually decrease using the predetermined value ΔT1 when the battery current That is larger than the current limit Ilim. However, the embodiment is not limited to this configuration, and the torque limit Tlim may be set to have a tendency to decrease as the battery current That increases as compared to the current limit Ilim. For example, proportional (P) control and proportional integration (PI) control based on a difference between the battery current That and the current limit Ilim may be used to set the torque limit Tlim.

In the hybrid vehicle 20, the torque limit Tlim is set based on the battery current Ibat, in addition to the energization state of the field coil 30a. However, the torque control limit Tlim may be set based on the energization state of the field coil 30a alone.

In the hybrid vehicle 20, power from the engine 22 is output to the front wheels 62a, 62b via the automatic transmission 24, and power from motor 32 is output to the rear wheels 64a, 64b. However, the power from the motor 32 may be output to the front wheels 62a, 62b and the power from the engine 22 may be output to the rear wheels 64a, 64b via the automatic transmission 24. Alternatively, the power from the engine 22 may be output to the front wheels 62a, 62b via the automatic transmission 24, with the power from motor 32 also being output to the front wheels 62a, 62a. Moreover, the power from the motor 32 may be output to the rear wheels 64a, 64b, with the power from the engine 22 also being output to the rear wheels 64a, 64b via the automatic transmission 24.

Hereinabove, the invention has been described with reference to a specific embodiment. However, the invention is in no way limited to this embodiment, and may be modified or changed in various different ways. It is to be understood that all such variations, modifications and different forms of the invention are intended to fall within the scope of the invention.

An on-off duty ratio of a transistor that increases and decreases a current applied to a field coil of an alternator is monitored. When the duty ratio is 100%, the electric generation capability of the alternator is at a maximum, and the battery current (Ibat) of a battery exceeds a predetermined current limit (Ilim). Under these conditions, a torque limit (Tlim) is set to tighten a limit on the torque output from a motor (S120, S130, S140). The motor is thus controlled within a range determined by the set torque limit (S190, S200). As a result, the motor can be controlled while the electric power outputs and requirements of the alternator, the battery and the motor are balanced, without having to directly detect the high voltage electric power of the alternator. Accordingly, the flow of excessive current in the battery can be impeded, and deterioration of the battery can be avoided.

The invention may be used in the automotive industry.

1-10. (canceled)

11. A power output apparatus that outputs power, comprising:
a motor that outputs power;
a generator that generates electric power while adjusting energization of an exciting coil, which is energized in accordance with energy consumed by the motor, and supplies the generated electric power to the motor;
an energization state detector that detects an energization state of the exciting coil; and
a controller that controls drive of the motor based on the detected energization state.

12. The power output apparatus according to claim 11, wherein the controller controls drive of the motor such that power output from the motor is restricted when the detected energization state of the exciting coil approaches a maximum value.

13. The power output apparatus according to claim 11, wherein the controller controls drive of the motor such that power output from the motor is restricted when the detected energization state of the exciting coil has reached a maximum value.

14. The power output apparatus according to claim 13, further comprising:
storage device that stores electric power from at least one of the generator and the motor and distributing electric power to at least one of the generator and the motor; and
discharge state detector that detects a discharge state of the storage device, wherein the controller controls drive of the motor based on both the detected energization state of the exciting coil and the detected discharge state of the storage device.

15. The power output apparatus according to claim 14, wherein
the controller controls drive of the motor such that power output from the motor is restricted when both the detected energization state of the exciting coil approaches the maximum value, and the detected discharge state of the storage device has become a predetermined discharge state.

16. The power output apparatus according to claim 14, wherein
the controller controls drive of the motor such that power output from the motor is restricted when both the detected energization state of the exciting coil has reached the maximum value, and the detected discharge state of the storage device has become a predetermined discharge state.

17. The power output apparatus according to claim 1 1, further comprising:
storage device that stores electric power from at least one of the generator and the motor and distributing electric power to at least one of the generator and the motor; and
discharge state detector that detects a discharge state of the storage device, wherein the controller controls drive of the motor based on both the detected energization state of the exciting coil and the detected discharge state of the storage device.

18. The power output apparatus according to claim 17, wherein
the controller controls drive of the motor such that power output from the motor is restricted when both the detected energization state of the exciting coil approaches the maximum value, and the detected discharge state of the storage device has become a predetermined discharge state.

19. The power output apparatus according to claim 17, wherein
the controller controls drive of the motor such that power output from the motor is restricted when both the detected energization state of the exciting coil has reached the maximum value, and the detected discharge state of the storage device has become a predetermined discharge state.

20. The power output apparatus according to claim 17, wherein
energization of the exciting coil is adjusted by changing a duty ratio so as to drive a switching device, and
the energization state detector detects the duty ratio.

21. The power output apparatus according to claim 17, wherein
the energization state detector detects an inter-terminal voltage of the exciting coil.

22. The power output apparatus according to claim 17, wherein the energization state detector detects current flowing in the exciting coil.

23. A vehicle that is equipped with the power output apparatus according to claim 17.

24. The power output apparatus according to claim 11, wherein energization of the exciting coil is adjusted by changing a duty ratio so as to drive a switching device, and
the energization state detector detects the duty ratio.

25. The power output apparatus according to claim 11, wherein
the energization state detector detects an inter-terminal voltage of the exciting coil.

26. The power output apparatus according to claim 11, wherein
the energization state detector detects current flowing in the exciting coil.

27. A vehicle that is equipped with the power output apparatus according to claim 11.
